(19) United States
(12) Patent Application Publication
(10) Pub. No.: US 2017/0003153 A1
(43) Pub. Date: Jan. 5, 2017

(54) WATER HEATER APPLIANCE AND A METHOD FOR DETECTING WATER DRAWS IN A WATER HEATER APPLIANCE

(71) Applicant: General Electric Company, Schenectady, NY (US)

(72) Inventors: Shaun Michael Ward, Louisville, KY (US); Brett Alan Farris, Louisville, KY (US)

(21) Appl. No.: 14/755,279

(22) Filed: Jun. 30, 2015

(51) Int. Cl. G01F 1/684

(52) U.S. Cl. CPC G01F 1/684

(57) ABSTRACT

A method for detecting water draws in a water heater appliance includes establishing a rate of change of temperature measurements of a first set of temperature measurements, establishing a rate of change of temperature measurements of a second set of temperature measurements, and determining that water is flowing through the water heater appliance based at least in part on the rates of change of the temperature measurements of the first and second sets of temperature measurements.

### FIELD OF THE INVENTION

The present subject matter relates generally to water heater appliance and methods for detecting fluid flow through water heater appliances.

### BACKGROUND OF THE INVENTION

Certain water heater appliances include a tank therein. Heating elements, such as gas burners, electric resistance elements, or induction elements, heat water within the tank during operation of such water heater appliances. In particular, the heating elements generally heat water within the tank to a predetermined temperature. The predetermined temperature is generally selected such that heated water within the tank is suitable for showering, washing hands, etc.

During operation, relatively cool water flows into the tank, and the heating elements operate to heat such water to the predetermined temperature. Thus, the volume of heated water available at the predetermined temperature is generally limited to the volume of the tank. According, water heater appliances are sold in various sizes to permit consumers to select a proper tank volume and provide sufficient heated water. However, large water heater appliances with large tanks occupy large amount of space within a residence or business. In certain buildings, space is limited and/or expensive. Thus, utilizing large water heater appliances can be impractical and/or prohibitively expensive despite needing large volumes of heated water.

To provide relatively large volumes of heated water from relatively small tanks, certain water heater appliances utilize a mixing valve. The mixing valve permits water within the water heater's tank to be stored at relatively high temperatures. The mixing valve mixes such high temperature water with relatively cool water in order to bring the temperature of such water down to suitable and/or more usable temperatures. Thus, such water heater appliance can provide relatively large volumes of heated water without requiring large tanks

To operate efficiently, water heater appliances with mixing valves generally determine whether hot water is in demand or is flowing. When water is flowing through the mixing valve, the mixing valve adjusts the ratio of relatively hot water and relatively cold water in order to control the temperature of water supplied downstream. Certain water heater appliances utilize a flowmeter or a flow sensor to determine if water is flowing through the mixing valve, but such devices can be unreliable. In particular, flowmeters and flow sensors include moving components that can clog or otherwise malfunction due to hard water or debris.

Accordingly, a water heater appliance having a mixing valve that includes features for determining when water is flowing through the mixing valve would be useful. In particular, a water heater appliance having a mixing valve that includes features for determining when water is flowing through the mixing valve without using a flowmeter or a flow sensor would be useful.

### BRIEF DESCRIPTION OF THE INVENTION

The present subject matter provides a method for detecting water draws in a water heater appliance. The method includes establishing a rate of change of temperature measurements of a first set of temperature measurements, establishing a rate of change of temperature measurements of a second set of temperature measurements, and determining that water is flowing through the water heater appliance based at least in part on the rates of change of the temperature measurements of the first and second sets of temperature measurements. A related water heater appliance is also provided. Additional aspects and advantages of the invention will be set forth in part in the following description, or may be apparent from the description, or may be learned through practice of the invention.

In one exemplary embodiment, a method for detecting water draws in a water heater appliance is provided. The method includes receiving a first set of temperature measurements at a controller of the water heater appliance from a temperature sensor positioned on a mixed water conduit of the water heater appliance. The temperature sensor is positioned on the mixed water conduit downstream of a mixing valve of the water heater appliance. The method also includes establishing a rate of change of the temperature measurements of the first set of temperature measurements with the controller of the water heater appliance, receiving a second set of second temperature measurements at the controller of the water heater appliance from the temperature sensor, establishing a rate of change of the temperature measurements of the second set of temperature measurements with the controller of the water heater appliance, and determining that water is flowing through the water heater appliance with the controller of the water heater appliance if the rate of change of the temperature measurements of the second set of temperature measurements is substantially greater or less than the rate of change of the temperature measurements of the first set of temperature measurements.

In another exemplary embodiment, a water heater appliance is provided. The water heater appliance includes a tank and a heated water conduit extending from the tank. A mixing valve is coupled to the heated water conduit, and a mixed water conduit extends from the mixing valve. A temperature sensor is positioned on the mixed water conduit downstream of the mixing valve. A controller is in operative communication with the mixing valve and the temperature sensor. The controller is configured for receiving a first set of temperature measurements from the temperature sensor, establishing a rate of change of the temperature measurements of the first set of temperature measurements, receiving a second set of second temperature measurements, establishing a rate of change of the temperature measurements of the second set of temperature measurements, and determining that water is flowing through the heated water conduit if the rate of change of the temperature measurements of the second set of temperature measurements is substantially greater or less than the rate of change of the temperature measurements of the first set of temperature measurements.

In yet another exemplary embodiment, a method for detecting water draws in a water heater appliance includes receiving a set of temperature measurements at a controller of the water heater appliance from a temperature sensor positioned on a mixed water conduit of the water heater appliance. The temperature sensor positioned on the mixed water conduit downstream of a mixing valve of the water heater appliance. The method also includes determining that water is flowing through the water heater appliance with the controller of the water heater appliance if the temperature measurements of the set of temperature measurements are substantially changing.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water heater appliance according to an exemplary embodiment of the present subject matter.

FIG. 2 provides a schematic view of certain components of the exemplary water heater appliance of FIG. 1.

FIG. 3 illustrates a method for detecting water draws through a water heater appliance according to an exemplary embodiment of the present subject matter.

FIG. 4 illustrates a plot of time versus temperature measurements and time versus flow rates according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

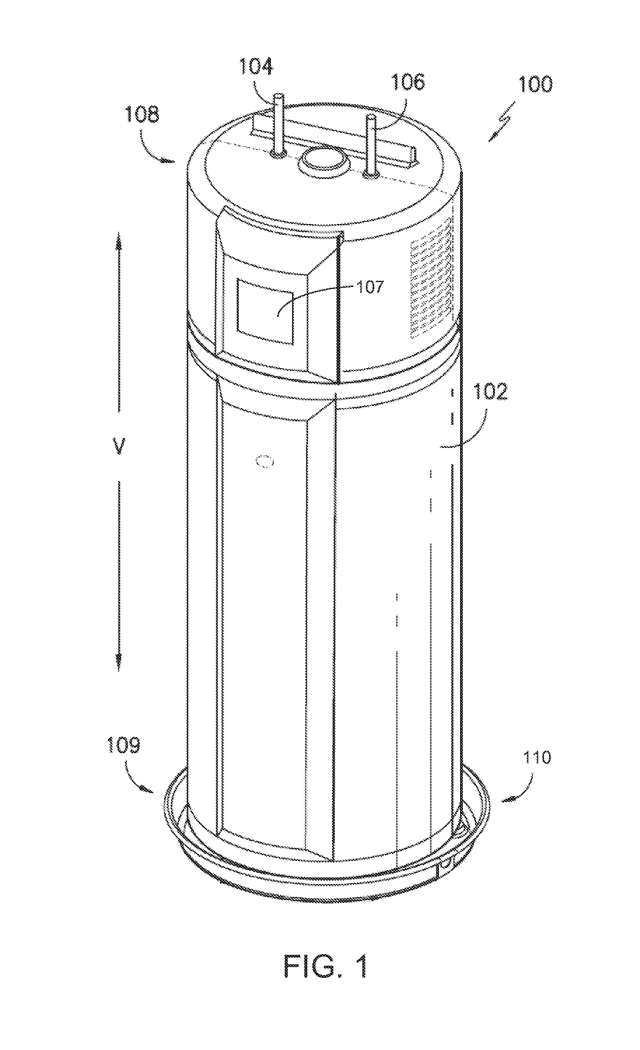

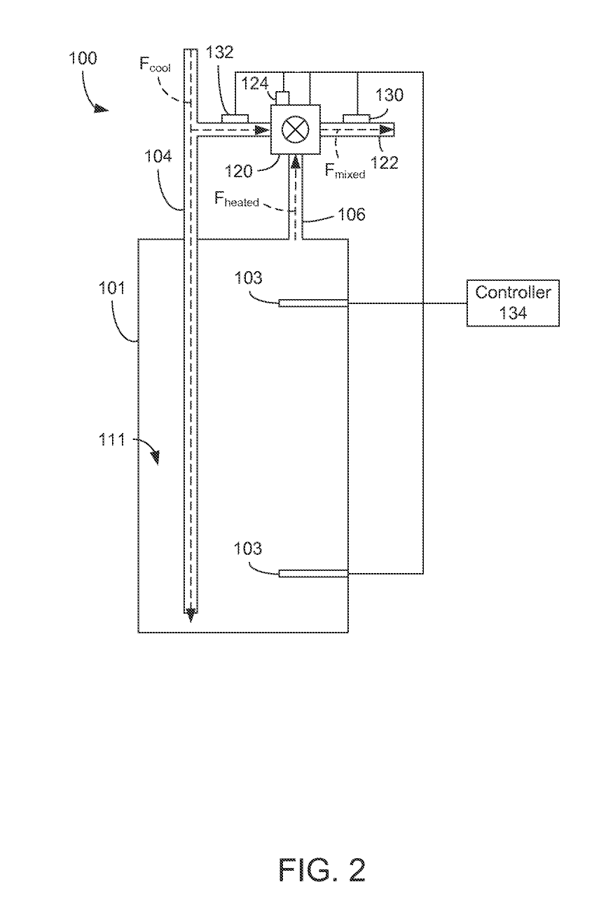

FIG. 1 provides a perspective view of a water heater appliance 100 according to an exemplary embodiment of the present subject matter. Water heater appliance 100 includes a casing 102. A tank 101 (FIG. 2) and heating elements 103 (FIG. 2) are positioned within casing 102 for heating water therein. Heating elements 103 may include a gas burner, a heat pump, an electric resistance element, a microwave element, an induction element, a sealed heat pump system or any other suitable heating element or combination thereof. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

Water heater appliance 100 also includes a cold water conduit 104 and a heated water conduit 106 that are both in fluid communication with a chamber 111 (FIG. 2) defined by tank 101. As an example, cold water from a water source, e.g., a municipal water supply or a well, can enter water heater appliance 100 through cold water conduit 104 (shown schematically with arrow labeled F_{cool} in FIG. 2). From cold water conduit 104, such cold water can enter chamber 111 of tank 101 wherein it is heated with heating elements 103 to generate heated water. Such heated water can exit water heater appliance 100 at heated water conduit 106 and, e.g., be supplied to a bath, shower, sink, or any other suitable feature.

Water heater appliance 100 extends longitudinally between a top portion 108 and a bottom portion 109 along a vertical direction V. Thus, water heater appliance 100 is generally vertically oriented. Water heater appliance 100 can be leveled, e.g., such that casing 102 is plumb in the vertical direction V, in order to facilitate proper operation of water heater appliance 100. A drain pan 110 is positioned at bottom portion 109 of water heater appliance 100 such that water heater appliance 100 sits on drain pan 110. Drain pan 110 sits beneath water heater appliance 100 along the vertical direction V, e.g., to collect water that leaks from water heater appliance 100 or water that condenses on an evaporator of water heater appliance 100. It should be understood that water heater appliance 100 is provided by way of example only and that the present subject matter may be used with any suitable water heater appliance.

FIG. 2 provides a schematic view of certain components of water heater appliance 100. As may be seen in FIG. 2, water heater appliance 100 includes a mixing valve 120 and a mixed water conduit 122. Mixing valve 120 is in fluid communication with cold water conduit 104, heated water conduit 106, and mixed water conduit 122. As discussed in greater detail below, mixing valve 120 is configured for selectively directing water from cold water conduit 104 and heated water conduit 106 into mixed water conduit 122 in order to regulate a temperature of water within mixed water conduit 122.

As an example, mixing valve 120 can selectively adjust between a first position and a second position. In the first position, mixing valve 120 can permit a first flow rate of relatively cool water from cold water conduit 104 (shown schematically with arrow labeled F_{cool} in FIG. 2) into mixed water conduit 122 and mixing valve 120 can also permit a first flow rate of relatively hot water from heated water conduit 106 (shown schematically with arrow labeled F_{heated} in FIG. 2) into mixed water conduit 122. In such a manner, water within mixed water conduit 122 (shown schematically with arrow labeled F_{mixed} in FIG. 2) can have a first particular temperature when mixing valve 120 is in the first position. Similarly, mixing valve 120 can permit a second flow rate of relatively cool water from cold water conduit 104 into mixed water conduit 122 and mixing valve 120 can also permit a second flow rate of relatively hot water from heated water conduit 106 into mixed water conduit 122 in the second position. The first and second flow rates of the relatively cool water and relatively hot water are different such that water within mixed water conduit 122 can have a second particular temperature when mixing valve 120 is in the second position. In such a manner, mixing valve 120 can regulate the temperature of water within mixed water conduit 122 and adjust the temperature of water within mixed water conduit 122 between the first and second particular temperatures.

It should be understood that, in certain exemplary embodiments, mixing valve 120 is adjustable between more positions than the first and second positions. In particular, mixing valve 120 may be adjustable between any suitable number of positions in alternative exemplary embodiments. For example, mixing valve 120 may be infinitely adjustable in order to permit fine-tuning of the temperature of water within mixed water conduit 122.

Mixing valve 120 may be an electronic mixing valve or a thermostatic mixing valve. In addition, mixing valve 120 may be positioned within casing 102, e.g., above tank 101. Thus, mixing valve 120 may be integrated within water heater appliance 100.

Water heater appliance 100 also includes a position sensor 124. Position sensor 124 is configured for determining a position of mixing valve 120. Position sensor 124 can monitor the position of mixing valve 120 in order to assist with regulating the temperature of water within mixed water conduit 122. For example, position sensor 124 can determine when mixing valve 120 is in the first position or the second position in order to ensure that mixing valve 120 is properly or suitably positioned depending upon the temperature of water within mixed water conduit 122 desired or selected. Thus, position sensor 124 can provide feedback regarding the status or position of mixing valve 120.

Water heater appliance 100 also includes a mixed water conduit temperature sensor or first temperature sensor 130 and a cold water conduit temperature sensor or second temperature sensor 132. First temperature sensor 130 is positioned on or proximate mixed water conduit 122 and is configured for measuring a temperature of water within mixed water conduit 122. First temperature sensor 130 is also positioned downstream of mixing valve 120. Second temperature sensor 132 is positioned on or proximate cold water conduit 104 and is configured for measuring a temperature of water within cold water conduit 104. Second temperature sensor 132 is positioned upstream of mixing valve 120. In certain exemplary embodiments, first temperature sensor 130 and/or second temperature sensor 132 may be positioned proximate or adjacent mixing valve 120.

Water heater appliance 100 further includes a controller 134 that is configured for regulating operation of water heater appliance 100. Controller 134 is in, e.g., operative, communication with heating elements 103, mixing valve 120, position sensor 124, and first and second temperature sensors 130 and 132. Thus, controller 134 can selectively activate heating elements 103 in order to heat water within chamber 111 of tank 101. Similarly, controller 134 can selectively operate mixing valve 120 in order to adjust a position of mixing valve 120 and regulate a temperature of water within mixed water conduit 122.

Controller 134 includes memory and one or more processing devices such as microprocessors, CPUs or the like, such as general or special purpose microprocessors operable to execute programming instructions or micro-control code associated with operation of water heater appliance 100. The memory can represent random access memory such as DRAM, or read only memory such as ROM or FLASH. The processor executes programming instructions stored in the memory. The memory can be a separate component from the processor or can be included onboard within the processor. Alternatively, controller 134 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 134 can be positioned at a variety of locations. In the exemplary embodiment shown in FIG. 1, controller 134 is positioned within water heater appliance 100, e.g., as an integral component of water heater appliance 100. In alternative exemplary embodiments, controller 134 may positioned away from water heater appliance 100 and communicate with water heater appliance 100 over a wireless connection or any other suitable connection, such as a wired connection.

Controller 134 can operate heating elements 103 to heat water within chamber 111 of tank 101. As an example, a user can select or establish a set-point temperature for water within chamber 111 of tank 101, or the set-point temperature for water within chamber 111 of tank 101 may be a default value. Based upon the set-point temperature for water within chamber 111 of tank 101, controller 134 can selectively activate heating elements 103 in order to heat water within chamber 111 of tank 101 to the set-point temperature for water within chamber 111 of tank 101. The set-point temperature for water within chamber 111 of tank 101 can be any suitable temperature. For example, the set-point temperature for water within chamber 111 of tank 101 may be between about one hundred and forty degrees Fahrenheit and about one hundred and eighty-degrees Fahrenheit.

Controller 134 can also operate mixing valve 120 to regulate the temperature of water within mixed water conduit 122. For example, controller 134 can adjust the position of mixing valve 120 in order to regulate the temperature of water within mixed water conduit 122. As an example, a user can select or establish a set-point temperature of mixing valve 120, or the set-point temperature of mixing valve 120 may be a default value. Based upon the set-point temperature of mixing valve 120, controller 134 can adjust the position of mixing valve 120 in order to change or tweak a ratio of relatively cool water flowing into mixed water conduit 122 from cold water conduit 104 and relatively hot water flowing into mixed water conduit 122 from heated water conduit 106. In such a manner, controller 134 can regulate the temperature of water within mixed water conduit 122.

The set-point temperature of mixing valve 120 can be any suitable temperature. For example, the set-point temperature of mixing valve 120 may be between about one hundred degrees Fahrenheit and about one hundred and twenty degrees Fahrenheit. In particular, the set-point temperature of mixing valve 120 may be selected such that the set-point temperature of mixing valve 120 is less than the set-point temperature for water within chamber 111 of tank 101. In such a manner, mixing valve 120 can utilize water from cold water conduit 104 and heated water conduit 106 to regulate the temperature of water within mixed water conduit 122.

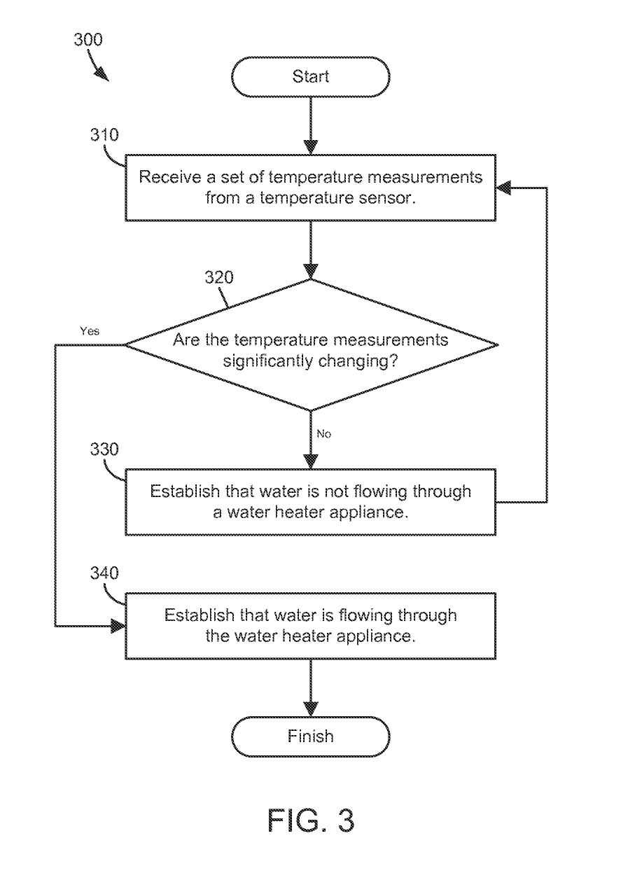

FIG. 3 illustrates a method 300 for operating a water heater appliance according to an exemplary embodiment of the present subject matter. Method 300 can be used to operate any suitable water heater appliance. For example, method 300 may be utilized to operate water heater appliance 100 (FIG. 1). Controller 134 of water heater appliance 100 may be programmed to implement method 300.

FIG. 3 illustrates a method 300 for detecting water draws through a water heater appliance according to an exemplary embodiment of the present subject matter. Method 300 may be used with any suitable water heater appliance. For example, method 300 may be used to determine whether water is flowing through mixed water conduit 122 in water heater appliance 100. In such a manner, method 300 can assist with operating water heater appliance 100, e.g., by assisting operation of mixing valve 120. In particular, knowledge of whether water is flowing through mixed water conduit 122 can assist mixing valve 120 with maintaining a proper or predetermined temperature for water within mixed water conduit 122. Controller 134 may be programmed or configured to implement method 300.

At step 310, first temperature sensor 130 provides a set of temperature measurements. Controller 134 may receive the set of temperature measurements from first temperature sensor 130 at step 310. Thus, the set of temperature measurements at step 310 may correspond to the temperature of water within mixed water conduit 122. As an example, controller 134 may measure the temperature of water within mixed water conduit 122 with first temperature sensor 130 at step 310.

At step 320, it is determined whether the temperature measurements of the set of temperature measurements from step 310 are significantly changing. When water heater appliance 100 is not experiencing a water draw event and water is not flowing through water heater appliance 100, the temperature of water within mixed water conduit 122 may be stable or may change slowly. As an example, heated water within tank 101 and/or heated water conduit 106 may slowly heat water within mixed water conduit 122. In particular, the temperature measurements of the set of temperature measurements from step 310 may increase or decrease at a rate less than one degree Fahrenheit per second when water heater appliance 100 is not experiencing a water draw event and water is not flowing through water heater appliance 100. Conversely, when water heater appliance 100 is experiencing a water draw event and water is flowing through water heater appliance 100, the temperature of water within mixed water conduit 122 may change significantly. As an example, heated water from tank 101 and/or heated water conduit 106 may rapidly increase the temperature of water within mixed water conduit 122 or cold water from cold water conduit 104 may rapidly decrease the temperature of water within mixed water conduit 122. In particular, the temperature measurements of the set of temperature measurements from step 310 may increase or decrease at a rate greater than five degrees Fahrenheit per second when water heater appliance 100 is experiencing a water draw event and water is flowing through water heater appliance 100. Thus, controller 134 may determine whether the temperature measurements of the set of temperature measurements from step 310 are significantly changing at step 320 in order to establish if water heater appliance 100 is experiencing a water draw event.

At step 330, controller 134 may establish that water heater appliance 100 is not experiencing a water draw event and water is not flowing through water heater appliance 100 if the temperature measurements of the set of temperature measurements from step 310 are not significantly changing at step 320. Conversely, controller 134 may establish that water heater appliance 100 is experiencing a water draw event and water is flowing through water heater appliance 100 at step 340 if the temperature measurements of the set of temperature measurements from step 310 are significantly changing at step 320.

Method 300 may utilize temperature measurements from first temperature sensor 130 to quickly and/or accurately determine whether water heater appliance 100 is experiencing a water draw event and water is flowing through water heater appliance 100. Thus, water heater appliance 100 need not include a flow meter or other device for mechanically detecting water draw events, in certain exemplary embodiments. During method 300, the temperature of water within chamber 111 of tank 101 is about (e.g., within five degrees Fahrenheit of) the set-point temperature for water within chamber 111 of tank 101. Thus, method 300 may include determining whether the temperature of water within chamber 111 of tank 101 is at about the set-point temperature for water within chamber 111 of tank 101 prior to step 310.

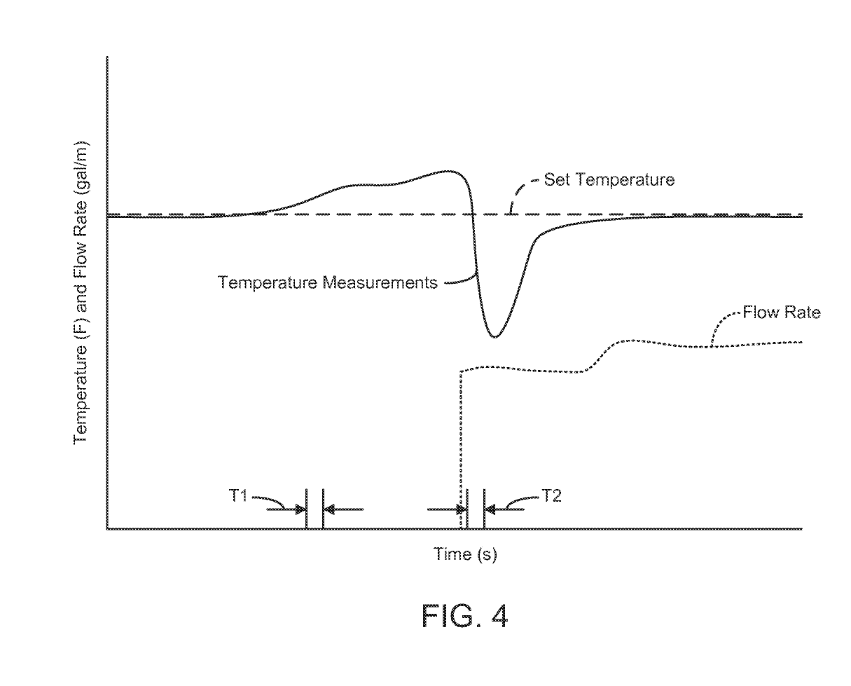

FIG. 4 illustrates a plot of time versus temperature measurements and time versus flow rates according to an exemplary embodiment of the present subject matter. An exemplary implementation of method 300 is discussed in greater detail below in the context of FIG. 4. As may be seen in FIG. 4, at step 310, controller 134 may receive a first set of temperature measurements during a first time period, T1, from first temperature sensor 130 positioned on mixed water conduit 122, e.g., downstream of mixing valve 120. The first set of temperature measurements may be gathered when water heater appliance 100 is not experiencing a water draw event and water is not flowing through water heater appliance 100. Thus, water heater appliance 100 is not experiencing a water draw event and water is not flowing through water heater appliance 100 during the first time period T1. The first time period T1 may be any suitable time period. For example, the first time period T1 may be one second, two second, three seconds, etc.

At step 320, controller 134 may establish a rate (e.g., average rate) of change of the temperature measurements of the first set of temperature measurements during the first time period T1. Because water heater appliance 100 is not experiencing a water draw event and water is not flowing through water heater appliance 100, controller 134 may determine that the temperature measurements of the first set of temperature measurements from step 310 are not significantly changing during the first time period T1 at step 320. Accordingly, controller 134 may establish that water heater appliance 100 is not experiencing a water draw event and water is not flowing through water heater appliance 100 during the first time period T1 at step 330. At step 320, an absolute value of the rate of change of the temperature measurements of the first set of temperature measurements over the first time period T1 may be no greater than one degree Fahrenheit per second.

As may be seen in FIG. 4, controller 134 may also receive a second set of temperature measurements from first temperature sensor 130 positioned on mixed water conduit 122, e.g., downstream of mixing valve 120, during a second period of time, T2, at step 310. The second set of temperature measurements may be gathered when water heater appliance 100 is experiencing a water draw event and water is flowing through water heater appliance 100. Thus, water heater appliance 100 is experiencing a water draw event and water is flowing through water heater appliance 100 during the second time period T2. The second time period T2 may be any suitable time period. For example, the second time period T2 may be one second, two second, three seconds, etc.

At step 320, controller 134 may establish a rate (e.g., average rate) of change of the temperature measurements of the second set of temperature measurements during the second time period T2. Because water heater appliance 100 is experiencing a water draw event and water is flowing through water heater appliance 100, controller 134 may determine that the temperature measurements of the second set of temperature measurements from step 310 are significantly changing during the second time period T2 at step 320. Accordingly, controller 134 may establish that water heater appliance 100 is experiencing a water draw event and water is flowing through water heater appliance 100 during the second time period T2 at step 340. At step 320, an absolute value of the rate of change of the temperature measurements of the second set of temperature measurements over the second time period T2 may be no less than five degrees Fahrenheit per second, no less than ten degrees Fahrenheit per second, etc.

In the above example, it should be understood that the rate of change of the temperature measurements of the second set of temperature measurements is substantially greater or less than the rate of change of the temperature measurements of the first set of temperature measurements. As used herein, the term “substantially” means at least three degrees Fahrenheit per second greater or less than the stated rate of change. Thus, method 300 may determine if water heater appliance 100 is experiencing a water draw event and water is flowing through water heater appliance 100 based at least in part on if the rate of change of the temperature measurements of the second set of temperature measurements is substantially greater or less than the rate of change of the temperature measurements of the first set of temperature measurements. As an example, controller 134 may determine that water heater appliance 100 is experiencing a water draw event and water is flowing through water heater appliance 100 if the (e.g., average or instantaneous) rate of change of the temperature measurements of the second set of temperature measurements is at least five degrees Fahrenheit per second greater or less than the (e.g., average or instantaneous) rate of change of the temperature measurements of the first set of temperature measurements. As another example, controller 134 may determine that water heater appliance 100 is experiencing a water draw event and water is flowing through water heater appliance 100 if the (e.g., average or instantaneous) rate of change of the temperature measurements of the second set of temperature measurements is at least ten degrees Fahrenheit per second greater or less than the (e.g., average or instantaneous) rate of change of the temperature measurements of the first set of temperature measurements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for detecting water draws in a water heater appliance, comprising:
receiving a first set of temperature measurements at a controller of the water heater appliance from a temperature sensor positioned on a mixed water conduit of the water heater appliance, the temperature sensor positioned on the mixed water conduit downstream of a mixing valve of the water heater appliance;
establishing a rate of change of the temperature measurements of the first set of temperature measurements with the controller of the water heater appliance;
receiving a second set of second temperature measurements at the controller of the water heater appliance from the temperature sensor;
establishing a rate of change of the temperature measurements of the second set of temperature measurements with the controller of the water heater appliance; and
determining that water is flowing through the water heater appliance with the controller of the water heater appliance if the rate of change of the temperature measurements of the second set of temperature measurements is substantially greater or less than the rate of change of the temperature measurements of the first set of temperature measurements.

2. The method of claim 1, wherein said step of determining comprises determining that water is flowing through the water heater appliance with the controller of the water heater appliance if the rate of change of the temperature measurements of the second set of temperature measurements is at least five degrees Fahrenheit per second greater or less than the rate of change of the temperature measurements of the first set of temperature measurements.

3. The method of claim 2, wherein said step of determining comprises determining that water is flowing through the water heater appliance with the controller of the water heater appliance if the rate of change of the temperature measurements of the second set of temperature measurements is at least ten degrees Fahrenheit per second greater or less than the rate of change of the temperature measurements of the first set of temperature measurements.

4. The method of claim 1, wherein an absolute value of the rate of change of the temperature measurements of the first set of temperature measurements is no greater than one degree Fahrenheit per second.

5. The method of claim 1, wherein an absolute value of the rate of change of the temperature measurements of the second set of temperature measurements is no less than ten degrees Fahrenheit per second.

6. The method of claim 1, wherein said step of determining comprises determining that water is flowing through the water heater appliance at said step of receiving the second set of second temperature measurements with the controller of the water heater appliance if the rate of change of the temperature measurements of the second set of temperature measurements is substantially greater or less than the rate of change of the temperature measurements of the first set of temperature measurements.

7. The method of claim 1, wherein water is not flowing through the water heater appliance during said step of receiving the first set of temperature measurements.

8. The method of claim 1, further comprising ascertaining that water is not flowing through the water heater appliance with the controller of the water heater appliance if the rate of change of the temperature measurements of the second set of temperature measurements is not substantially greater or less than the rate of change of the temperature measurements of the first set of temperature measurements.

9. The method of claim 1, wherein the mixing valve is an electronic mixing valve or a thermostatic mixing valve.

10. The method of claim 1, wherein the mixing valve is positioned within a casing of the water heater appliance.

11. A water heater appliance, comprising:
a tank;
a heated water conduit extending from the tank;
a mixing valve coupled to the heated water conduit;
a mixed water conduit extending from the mixing valve;
a temperature sensor positioned on the mixed water conduit downstream of the mixing valve; and
a controller in operative communication with the mixing valve and the temperature sensor, the controller configured for
receiving a first set of temperature measurements from the temperature sensor;
establishing a rate of change of the temperature measurements of the first set of temperature measurements;
receiving a second set of second temperature measurements;
establishing a rate of change of the temperature measurements of the second set of temperature measurements; and
determining that water is flowing through the heated water conduit if the rate of change of the temperature measurements of the second set of temperature measurements is substantially greater or less than the rate of change of the temperature measurements of the first set of temperature measurements.

12. The water heater appliance of claim 11, wherein the controller is configured for determining that water is flowing through the heated water conduit if the rate of change of the temperature measurements of the second set of temperature measurements is at least five degrees Fahrenheit per second greater or less than the rate of change of the temperature measurements of the first set of temperature measurements.

13. The water heater appliance of claim 12, wherein the controller is configured for determining that water is flowing through the heated water conduit if the rate of change of the temperature measurements of the second set of temperature measurements is at least ten degrees Fahrenheit per second greater or less than the rate of change of the temperature measurements of the first set of temperature measurements.

14. The water heater appliance of claim 11, the controller is further configured for ascertaining that water is not flowing through the heated water conduit if the rate of change of the temperature measurements of the second set of temperature measurements is not substantially greater or less than the rate of change of the temperature measurements of the first set of temperature measurements.

15. The water heater appliance of claim 11, wherein the mixing valve is an electronic mixing valve or a thermostatic mixing valve.

16. The water heater appliance of claim 11, further comprising a casing, the tank disposed within the casing, the mixing valve positioned within the casing over the tank.

17. The water heater appliance of claim 11, wherein the mixed water conduit extends through the casing at a top portion of the casing.

18. A method for detecting water draws in a water heater appliance, comprising:
receiving a set of temperature measurements at a controller of the water heater appliance from a temperature sensor positioned on a mixed water conduit of the water heater appliance, the temperature sensor positioned on the mixed water conduit downstream of a mixing valve of the water heater appliance; and
determining that water is flowing through the water heater appliance with the controller of the water heater appliance if the temperature measurements of the set of temperature measurements are substantially changing.
